(19) United States
(12) Patent Application Publication
(10) Pub. No.: US 2010/0207876 A1
(43) Pub. Date: Aug. 19, 2010

(54) LASER SCANNING INPUT DEVICE

(76) Inventor: CHIH-HSIUNG LIN, Jhonghe City (TW)

Correspondence Address: G. LINK CO., LTD., 3550 BELL ROAD, MINOOKA, IL, 60447, US

(21) Appl. No.: 12/701,435

(22) Filed: Feb. 5, 2010

(30) Foreign Application Priority Data
Feb. 16, 2009 (TW) 098104796

(51) Int. Cl. G06F 3/01

(52) U.S. Cl. 345/156

(57) ABSTRACT

A laser scanning input device includes a horizontal scanning laser device, an image capturing device and a microprocessor, and uses a laser beam to scan a target horizontally and the image capturing device to capture a reflected image reflected from a target. Besides, the laser scanning input device further calculate and obtain a coordinate of the target through the microprocessor and take it as corresponding input information. Therefore, the speed of obtaining the target coordinate can be increased, and a three dimensional profile information of the target corresponding to the target can further be obtained.

### BACKGROUND OF THE INVENTION

1. Field of the Invention

The present invention relates to an information input device, and more particularly to an input device used for detecting a target coordinate and taking it as input information.

2. Description of Related Art

A several information input device detects a target coordinate and takes it as the input information of characters, patterns and symbols corresponding thereto, or takes it as input information of an interactive game machine.

Taiwan Patent No. I303773 discloses an information input device, including a microprocessor electrically connected to an image capturing device; a mirror is placed in front of a lens of the image capturing device, thereby allowing the image capturing device captures a reference image reflected by the mirror. When the microprocessor detects the image capturing device capturing that a user touches the reference image of at least one input zone of an image, and then generate a corresponding input signal according to the image capturing device capturing that the user touches the input image of the input zones.

Taiwan Patent Publishing No. 200813785 discloses an image position interpretation device, utilizing first and second reflecting mirrors to respectively reflect a targert's image to at least one lens of a image capturing device, and the targert's image is respectively captured as first and second images by the lens. A microprocessor processes the first and second images to obtain a corresponding coordinate value in the scope of an input operating face, where a horizontal optical axis of at least one image capturing device is parallel to the input operating face.

U.S. Pat. No. 7,202,860 discloses a coordinate input device working with at least display screen and desk-top surface as the pointing areas thereof, including a pair of cameras positioned in an upper left position and an upper right position of a display screen of a monitor lying close to a plane extending from the display screen of the monitor and views both a side face of an object in contact with a position on the display screen and a predetermined desk-top coordinate detection area to capture the image of the object within the field of view. The coordinate input device also includes a control circuit which calculates the coordinate value of a pointing tool, pointing to a position within a coordinate detection field, based on video signals output from the pair of cameras, and transfers the coordinate value to a program of a computer.

### SUMMARY OF THE INVENTION

To increase the speed of the detection and calculation of a target coordinate and reduce the production cost of an input device, the present invention is proposed.

The main object of the present invention is to provide a laser scanning input device, utilizing laser to scan a target levelly, and operate in coordination with an image capturing device to capture the reflected laser reflected from the target so as to calculate a coordinate of the target, thereby taking it as corresponding input information such that the target coordinate acquiring speed can be increased.

Another object of the present invention is to provide a laser scanning input device, capable of reducing the production cost of an input device.

### BRIEF DESCRIPTION OF THE DRAWINGS

The present invention can be more fully understood by reference to the following description and accompanying drawings, in which:

FIG. 1 is a block chart, showing the functional structure of a laser scanning input device of a first preferred embodiment according to the present invention;

FIG. 2 is a schematic view, showing an image capturing device of the present invention while capturing a long strip type image.

FIG. 3 is a schematic view, showing a laser scanning input device of the first embodiment according to the present invention;

FIG. 4 is a schematic view, showing a laser scanning input device of a second preferred embodiment according to the present invention; and

FIG. 5 is a schematic view, showing a laser scanning input device of a third preferred embodiment according to the present invention.

### DETAILED DESCRIPTION OF THE PREFERRED EMBODIMENTS

A laser scanning input device of the present invention utilizes laser to scan a target levelly and an image capturing device to capture a reflected laser image reflected from the target, and further to calculate a target coordinate and take it as corresponding input information.

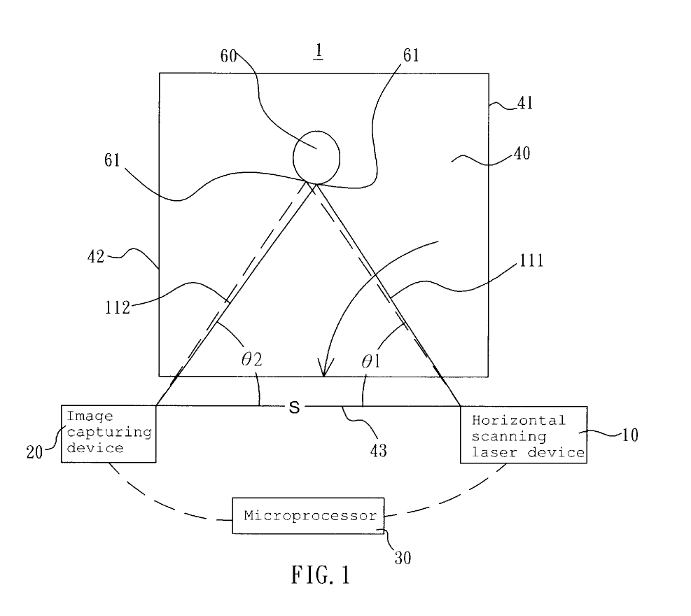

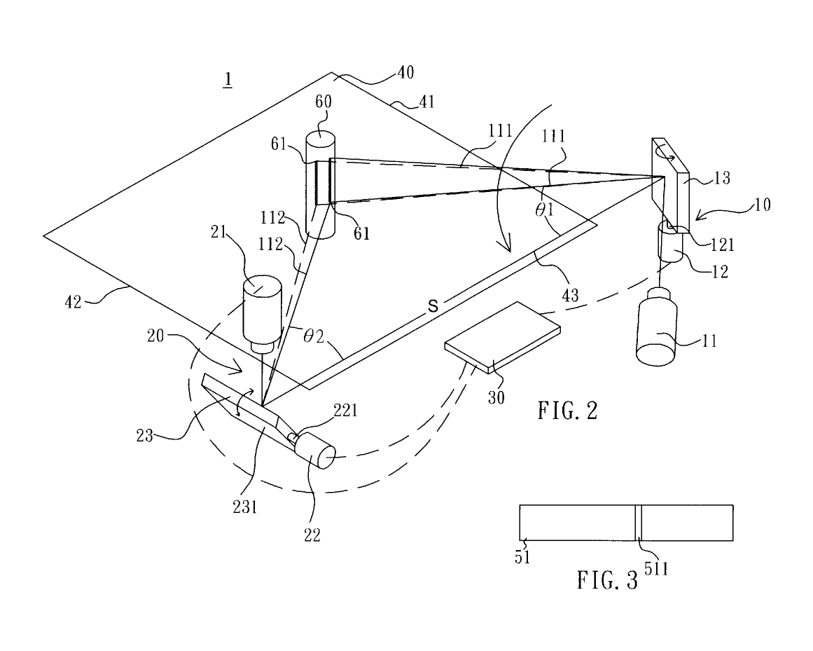

Referring to FIGS. 1 and 2, an input device 1 of a first preferred embodiment according to the present invention includes a horizontal scanning laser device 10, an image capturing device 20 and a microprocessor 30, where the microprocessor 30 may be in radio or wired connection with the horizontal scanning laser device 10 and the image capturing device 20. The microprocessor 30 allows a laser beam 111 emitted from the horizontal scanning laser device 10 to scan from one end 41 of an input operating face 40 to another end 42 thereof. When the laser beam 111 is projected on a target 60 and an illuminated region 61 is formed on target 60, the microprocessor 30 allows the image capturing device 20 to capture a reflected laser beam 112 reflected from the illuminated region 61 of the target 60, and a corresponding laser image 511 is formed on an image 51 captured by the image capturing device 20 as FIG. 20 shows. The length of a connecting line S43 between the horizontal scanning laser device 10 and the image capturing device 20 is fixed; the included angle between the laser beam 111 projected on the illuminated region 61 of the target 60 and the connecting line S43 is defined as an angle θ1 and the included angle between the reflected laser beam 112 and the connecting line S43 is defined as an angle θ2. The angle θ1 is a rotating angle of the scanning of the laser beam 111. The microprocessor 30 can obtain the value of the angle θ2 from the position of the laser image 511 on the image 51 depending on a corresponding record, and calculate a coordinate of the illuminated region 61 on the target 60 depending on the angle θ1, the angle θ2 and the length of the connecting line S43 so as to take it as input information.

Referring to FIG. 2 again, the horizontal scanning laser device 10 of the present invention includes a laser module 11, a first motor 12 and a first mirror 13, where a first rotating shaft 121 of the first motor 12 is coupled to the first mirror 13 and can drive the first mirror 13 to rotate 360 degree continuously. The laser module 11 can emit a linear or dotted laser beam 111.

Referring to FIGS. 2 and 3, the image capturing device 20 of the present invention includes an image capturing module 21, a second motor 22 and a second mirror 23, where a second rotating shaft 221 of the second motor 22 is coupled to the second mirror 23, and can drive the second mirror 23 to change an inclined angle of a mirror surface 231 thereof. The mirror surface 231 of the second mirror 23 is inclined to a physical or virtual input operating face 40 approximately 45 degree. The image capturing module 21 is positioned exactly over the second mirror 23. The second mirror 23 is a long strip type body, and the image capturing module 21 can capture a long strip type image 51 through the second mirror 23 as indicated in the aforementioned Taiwan Patent No. 1303773.

Please refer to FIGS. 1, 2 and 3. When the target 60 is carrying out an input operation on the input operating face 40, the microprocessor 30 allows the laser beam 111 emitted from the laser module 11 to scan from one end 41 of the input operating face 40 to another end 42 thereof repeatedly by means of the reflection of the rotating first mirror 12, and is projected on the target 60 to form the illuminated region 61 on the target 60, where the illuminated region 61 may be linear or dotted. The microprocessor 30 allows the image capturing module 21 to capture the reflected laser beam 112 reflected from the illuminated region 61 of the target 60 and form a corresponding laser image 511 on the image 51 as FIG. 3 shows.

Please refer to FIGS. 1 and 2 again. The microprocessor 30 may be in radio or wired connection with the first motor 12 of the horizontal scanning laser device 10, the image capturing module 21 of the image capturing device 20 and the second motor 22.

Referring to 1, 2 and 3 again, because the length of the connecting line S43 between the horizontal scanning laser device 10 and the image capturing device 20 is fixed, the corresponding coordinate value of the illuminated region 61 can be calculate if the values of the included angle θ1 between the laser beam 111 projected on the illuminated region 61 of the target 60 and the included angle θ2 reflected from the illuminated region 61 of the target 60 are known.

Because the angle θ1 corresponds to the rotating angle of the first rotating shaft 121 of the first motor 12, the value of the angle θ1 can be obtained from the rotating angle of the first rotating shaft 121. The value of the angle θ2 corresponds to the position of the laser image 511 on the image 51, a corresponding record of the angle θ2 and the position of the laser image 511 on the image 51 can be first recorded experimentally, and the value of the angle θ2 can be obtained from the position of the laser image 511 on the image 51 depending on the corresponding record. The microprocessor 30 can obtain the values of the angles θ1, θ2 by detecting the output information of the first motor 12 and the image capturing module 21, and can then calculate and obtain the coordinate of the illuminated region 61 of the target 60 by further operating in coordination with the know length of the connecting line S43 so as to take it as input information.

When the microprocessor 30 allows the scanning of the laser beam 111, the scanning from one end 41 of the input operating face 40 to another end 42 thereof is one cycle, and the time of every one scanning cycle is divided into n divisions; the microprocessor 30 allows the image capturing module 21 to carry out one image capturing action in every one time division. No reflected laser 112 is reflected if the laser beam 111 is not projected on the target 60, there is no laser image 511 in the image 51 captured by the image capturing module 21; if the laser beam 111 is projected on the target 60, the reflected laser beam 112 is reflected such that the laser image 511 is found in the image 51 captured by the image capturing module 21, and every division of laser image 511 can be captured and a corresponding coordinate can be calculated.

The profile information of the target 60 at the same horizontal cross section can then be obtained by capturing the laser images 511 of the reflected laser beams 112 reflected by a plurality of continuous reflected regions 61 on the target 60 when the microprocessor 30 is used to allow the scanning of the laser beam 111 in one cycle. The second motor 22 is allowed to drive the second mirror 23 to change the inclined angle of the mirror surface 231 after the one cycle of the scanning of the laser beam 111, and the profile information of the target 60 at another horizontal cross section can be obtained by means of the aforementioned manner; a three dimensional profile information corresponding to the target 60 can further be obtained through the profile information corresponding to the target 60 at a plurality of continuous horizontal cross sections so as to carry out an input of the three dimensional profile information corresponding to the target 60.

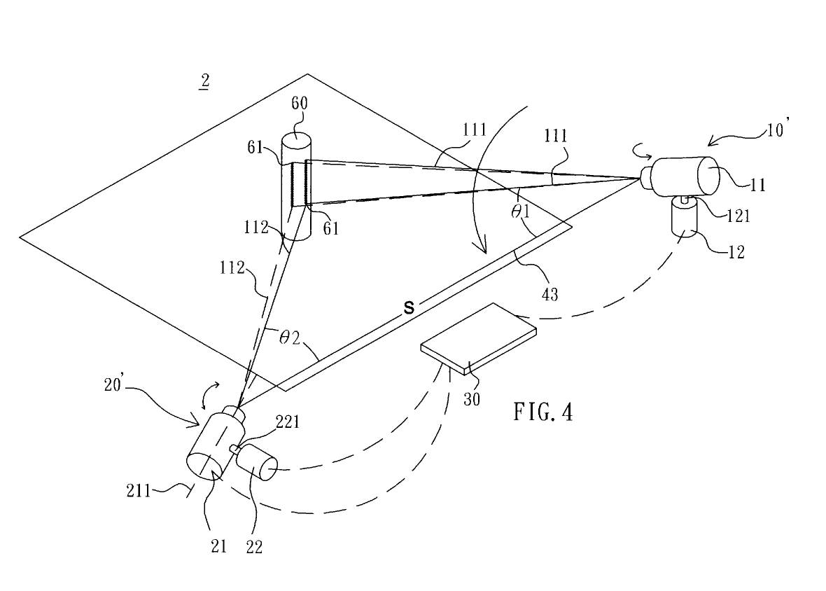

Referring to FIG. 4, an input device 2 of a second preferred embodiment according to the present invention includes a horizontal scanning laser device 10′, an image capturing device 20′ and a microprocessor 30, where the microprocessor 30 may be in radio or wired connection with the horizontal scanning laser device 10′ and the image capturing device 20′.

The horizontal scanning laser device 10′ of the present embodiment includes a laser module 11 and a first motor 12. A first rotating shaft 121 of the first motor 12 is coupled to the laser module 11 and can drive the laser module 11 to rotate 360 degrees. The laser module 11 may emit a linear or dotted laser beam 111. The present embodiment may also replace the horizontal scanning laser device 10′ with the horizontal scanning laser device 10 of the first embodiment.

The image capturing device 20′ of the present embodiment includes an image capturing module 21 and a second motor 22. A second rotating shaft 221 of the second motor 22 is coupled to the image capturing module 21 and can drive the image capturing module 21 to change the inclined angle thereof. A shaft 211 of the image capturing module 21 is aligned with a virtual input operating face 40. The image capturing module 21 can capture a long strip type image 51 from the virtual input operating face 40 to a distance at a small distance over the virtual input operating face 40.

When the target 60 is carrying out an input operation on the input operating face 40, the microprocessor 30 allows the laser beam 111 emitted from the laser module 11 to scan from one end 41 of the input operating face 40 to another end 42 thereof repeatedly, and is projected on the target 60 continuously to form the illuminated regions 61 on the target 60 continuously, where the illuminated region may be linear or dotted. The image capturing module 21 can capture the reflected laser beam 112 reflected from the illuminated region 61 of the target 60 and forms a corresponding laser image 511 on the image 51.

The microprocessor 30 may be in radio or wired connection with the first motor 12 of the horizontal scanning laser device 10′, and the image capturing module 21 and the second motor 22 of the image capturing device 20′.

As described in the aforementioned first embodiment, the microprocessor 30 can obtain the values of the angles θ1 and θ2 by detecting the output information of the first motor 12 and the image capturing module 22, operate in coordination with the known length of the connecting line S and can then calculate and obtain a coordinate of the illuminated region 61 on the target 60 so as to take it as input information and further obtain a three dimensional profile information corresponding to the target 60, thereby carrying out the input of the three dimensional profile information corresponding to the target 60.

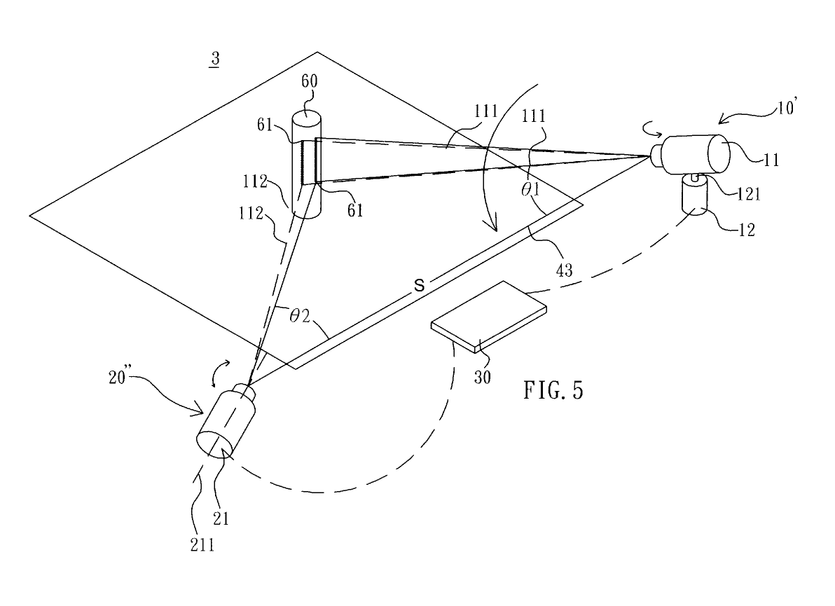

Referring to FIG. 5, an input device 3 of a third preferred embodiment of the present invention includes a horizontal scanning laser device 10′, an image capturing device 20″ and a microprocessor 30, where the microprocessor 30 can be in radio or wired connection with the horizontal scanning laser device 10′ and the image capturing device 20″.

The horizontal scanning laser device 10′ of the present embodiment includes a laser module 11 and a first motor 12, where a first rotating shaft 121 of the first motor 12 is coupled to the laser module 11, and can drive the laser module 11 to rotate 360 degrees continuously. The laser module 11 may emit a linear or dotted laser beam 111. The present embodiment may also replace the horizontal scanning laser device 10′ with the horizontal scanning laser device 10 of the first embodiment.

The image capturing device 20″ of the present embodiment includes an image capturing module 21, where a shaft of the image capturing module 21 is aligned with a virtual input operating face 40. The image capturing module 21 can capture a long strip type image 51 from the virtual input operating face 40 to a distance at a small distance over the virtual input operating face 40.

When the target 60 is carrying out an input operation on the input operating face 40, the laser beam 111 emitted from the laser module 11 can scan from one end 41 of the input operating face 40 to another end 42 thereof repeatedly, and is projected on the target 60 continuously to form illuminated regions 61 on the target 60 continuously, where the illuminated region 61 may be linear or dotted. The image capturing module 21 can capture the reflected laser beam 112 reflected from the illuminated region 61 of the target 60 and form a corresponding laser image 511 on the image 51.

The microprocessor 30 may be in radio or wired connection with the first motor 12 of the horizontal scanning laser device 10′ and the image capturing module 21 and the second motor 22 of the image capturing device 20″.

As described in the aforementioned first embodiment, the microprocessor 30 can obtain the values of the angles θ1 and θ2 by detecting the output information of the first motor 12 and the image capturing module 22, operate in coordination with the known length of the connecting line S and can then calculate and obtain the coordinate of the illuminated region 61 on the target 60 so as to take it as input information.

The first motor 12 of the present invention can rotate at least M times every second, thereby allowing the laser beam emitted form the laser module can scan the input operating face at least M times every second. The image capturing module of the present invention can be a digital camera or linear image sensor, and can capture at least M multiplied by N images every second, where M and N respectively are a natural number. The laser module of the present invention may be infrared laser module, ensuring that a operator cannot seethe laser beam and the illuminated region on the target. Because the image capturing speed of the image capturing module is matched with the speed of the laser scanning on the input operation face, the faster the speed is, the more accurate the coordinate or profile information of the target can be detected.

The laser scanning input device of the present invention does not need a complex image process and analysis, only refers to former record to obtain the position of the laser image on the image, thereby obtaining the corresponding angle value, and operate in coordination with the known laser scanning angle and the length of the connecting line between the horizontal scanning laser device and the image capturing device. Thereafter, it can then calculate and obtain the coordinate of the target. Therefore, the speed of obtaining the target coordinate can be increased and the three dimensional profile information corresponding to the target can further be obtained.

The laser scanning input device of the present invention only needs one image capturing module and one laser module, and the cost of the components put to use is low such that the production cost of the input device can be decreased.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A laser scanning input device, comprising:
a horizontal scanning laser device, a laser beam emitted therefrom scanning from one end of an input operating face to another end thereof;
an image capturing device;
a microprocessor, being in one of radio and wired connections with said horizontal scanning laser device and said image capturing device;
wherein, when said microprocessor allows said laser beam emitted from said horizontal scanning laser device to be projected on a target and form an illuminated region on said target, said microprocessor allows said image capturing module to capture a reflected laser beam reflected from said illuminated region of said target and form a laser image corresponding thereto on a image captured by said image capturing module; a length of a connecting line between said horizontal scanning laser device and said image capturing device is fixed; said laser beam projected on said illuminated region of said target and said reflected laser beam reflected therefrom respectively form included angles θ1 and θ2 with said connecting line; said angle θ1 is a rotating angle of a scanning of said laser beam; said microprocessor obtains a value of said angle θ2 from a position of said laser image on said image depending on a corresponding record; said microprocessor calculates a coordinate of said illuminated region of said target depending on said angles θ1 and θ2 and said length of said connecting line to take said coordinate as input information.

2. The laser scanning input device according to claim 1, wherein said horizontal scanning laser device comprises a laser module, a first motor and a first mirror; a first rotating shaft of said first motor is coupled to said first mirror and drives said first mirror to rotate 360 degrees; said laser module emits said laser beam; said laser beam scans from one end of said input operating face to another end thereof repeatedly by means of a reflection of said rotating first mirror.

3. The laser scanning input device according to claim 2, wherein said image capturing device comprises an image capturing module; said image capturing module captures said long strip type image from said input operating face to a distance at a small distance over said input operating face.

4. The laser scanning input device according to claim 3, wherein said image capturing device comprises a second motor; a second rotating shaft of said second motor is coupled to said image capturing module so as to drive said image capturing module to change an inclined angle of said image capturing module.

5. The laser scanning input device according to claim 2, wherein said image capturing device comprises an image capturing module, a second motor and a second mirror; a second rotating shaft of said second motor is coupled to said second mirror to drive said second mirror to change an inclined angle of a mirror surface thereof; said image capturing module is positioned exactly over said second mirror; said second mirror is a long strip type body, allowing said image capturing module to capture a long strip type of said image through said second mirror.

6. The laser scanning input device according to claim 4, wherein, when said microprocessor allows a scanning of said laser beam emitted from said horizontal scanning laser device, said scanning from one end of said input operating face to another end thereof is one cycle and time for scanning every one cycle is divided into n divisions, said image capturing module carries out one image capturing action in every time division, wherein said n is a natural number.

7. The laser scanning input device according to claim 5, wherein, when said microprocessor allows a scanning of said laser beam emitted from said horizontal scanning laser device, said scanning from one end of said input operating face to another end thereof is one cycle and time for scanning every one cycle is divided into n divisions, said image capturing module carries out one image capturing action in every time division, wherein said n is a natural number.

8. The laser scanning input device according to claim 6, wherein said microprocessor allows said laser scanning of said horizontal scanning laser device in one cycle, and obtains profile information of said target at the same horizontal cross section by capturing said laser images of said reflected laser beams reflected from the plurality of continuous illuminated regions on said target; said second motor is allowed to drive said image capturing module to change said inclined angle thereof after said laser beam scans one cycle to obtain profile information of said target at another horizontal cross section; three dimensional profile information corresponding to said target is further obtained from said profile information corresponding to said plurality of continuous illuminated regions of said target so as to carry out an input of said three dimensional profile information corresponding to said target.

9. The laser scanning input device according to claim 7, wherein said microprocessor allows said laser scanning of said horizontal scanning laser device in one cycle, and obtains profile information of said target at the same horizontal cross section by capturing said laser images of said reflected laser beams reflected from the plurality of continuous illuminated regions on said target; said second motor is allowed to drive said second motor to change said inclined angle of a mirror surface thereof after said laser beam scans one cycle to obtain profile information of said target at another horizontal cross section; three dimensional profile information corresponding to said target is further obtained from said profile information corresponding to said plurality of continuous illuminated regions of said target so as to carry out an input of said three dimensional profile information corresponding to said target.

10. The laser scanning input device according to claims 3, wherein said image capturing module is one of a digital camera and a linear image sensor.

11. The laser scanning input device according to claim 10, wherein said laser beam is one of a linear laser beam and a dotted laser beam.

12. The laser scanning input device according to claim 1, wherein said horizontal scanning laser device comprises a laser module and a first motor; a first rotating shaft of said first motor is coupled to said laser module and drives said laser module to rotate 360 degrees; said laser module emits said laser beam and said laser beam scans from one end of said input operating face to another end thereof repeatedly.

13. The laser scanning input device according to claim 12, wherein said image capturing device comprises an image capturing module; a shaft of said image capturing module is aligned with said input operating face; said image capturing module captures said long strip type image from said input operating face to a distance at a small distance over said input operating face.

14. The laser scanning input device according to claim 13, wherein said image capturing device comprises a second motor; a second rotating shaft of said second motor is coupled to said image capturing module to drive said image capturing module to change an inclined angle of said image capturing module.

15. The laser scanning input device according to claim 12, wherein said image capturing device comprises an image capturing module, a second motor and a second mirror; a second rotating shaft of said second motor is coupled to said second mirror to drive said second mirror to change an inclined angle of a mirror surface thereof; said image capturing module is positioned exactly over said second mirror; said second mirror is a long strip type body, allowing said image capturing module to capture a long strip type of said image through said second mirror.

16. The laser scanning input device according to claim 14, wherein, when said microprocessor allows a scanning of said laser beam emitted from said horizontal scanning laser device, said scanning from one end of said input operating face to another end thereof is one cycle and time for scanning every one cycle is divided into n divisions, said image capturing module carries out one image capturing action in every time division, wherein said n is a natural number.

17. The laser scanning input device according to claim 15, wherein, when said microprocessor allows a scanning of said laser beam emitted from said horizontal scanning laser device, said scanning from one end of said input operating face to another end thereof is one cycle and time for scanning every one cycle is divided into n divisions, said image capturing module carries out one image capturing action in every time division, wherein said n is a natural number.

18. The laser scanning input device according to claim 16, wherein said microprocessor allows said laser scanning of said horizontal scanning laser device in one cycle, and obtains profile information of said target at the same horizontal cross section by capturing said laser images of said reflected laser beams reflected from the plurality of continuous illuminated regions on said target; said second motor is allowed to drive said image capturing module to change said inclined angle thereof after said laser beam scans one cycle to obtain profile information of said target at another horizontal cross section; three dimensional profile information corresponding to said target is further obtained from said profile information corresponding to said plurality of continuous illuminated regions of said target so as to carry out an input of said three dimensional profile information corresponding to said target.

19. The laser scanning input device according to claim 17, wherein said microprocessor allows said laser scanning of said horizontal scanning laser device in one cycle, and obtains profile information of said target at the same horizontal cross section by capturing said laser images of said reflected laser beams reflected from the plurality of continuous illuminated regions on said target; said second motor is allowed to drive said image capturing module to change said inclined angle thereof after said laser beam scans one cycle to obtain profile information of said target at another horizontal cross section; three dimensional profile information corresponding to said target is further obtained from said profile information corresponding to said plurality of continuous illuminated regions of said target so as to carry out an input of said three dimensional profile information corresponding to said target.

20. The laser scanning input device according to claim 13, wherein said image capturing module is one of a digital camera and a linear image sensor.

21. The laser scanning input device according to claim 20, wherein said laser beam is one of a linear laser beam and a dotted laser beam.

22. The laser scanning input device according to claim 11, wherein said laser beam is an infrared laser beam.

23. The laser scanning input device according to claim 21, wherein said laser beam is an infrared laser beam.
